(19) United States
(12) Patent Application Publication
(10) Pub. No.: US 2004/0149946 A1
(43) Pub. Date: Aug. 5, 2004

(54) Throttle valve assembly

(75) Inventors: Guenther Bender, Rodheim (DE); Axel Goessling, Friedrichsdorf (DE); Joerg Krueger, Frankfurt (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AG, MUNICH (DE)

(21) Appl. No.: 10/740,792

(22) Filed: Dec. 22, 2003

Related U.S. Application Data
(63) Continuation of application No. PCT/DE02/02282, filed on Jun. 21, 2002.

(30) Foreign Application Priority Data
Jul. 12, 2001 (DE) 10133294.7

(51) Int. Cl. F16K 31/02

(52) U.S. Cl. 251/129.04

(57) ABSTRACT

The invention relates to a throttle valve housing comprising a housing having a continuous throttle hole that can be cross flown by a gaseous medium in a main flow direction, wherein said throttle valve shaft can be pivoted by an actuating drive and wherein the throttle hole is connected to an inlet line on the inlet side and to an outlet line on the outlet side. The invention aims at ensuring particularly reliable detection of the mass of gaseous medium coming in through the throttle hold, using particularly simple means. This is achieved in that a first temperature sensor for temperature T of the gaseous medium is arranged upstream of the throttle valve and in that a second pressure sensor for pressure P of the gaseous medium is arranged downstream of the throttle valve.

### CROSS REFERENCE TO RELATED APPLICATIONS

The present application is a continuation of international application PCT/DE02/02282, filed on Jun. 21, 2002, which designated the United States and claims priority to German reference 10133294.7, filed on Jul. 21, 2001, the both of which are herein incorporated by reference.

### BACKGROUND OF THE INVENTION

The invention relates to a throttle valve assembly with a housing which has a continuous throttle orifice through which a gaseous medium is capable of flowing in a main flow direction, a throttle valve fastened pivotably to a throttle valve shaft being arranged in the throttle orifice, the throttle valve shaft being pivotable by an actuating drive, and the throttle orifice being connected on the inlet side to an inlet line and on the outlet side to an outlet line.

Throttle valve assemblies are conventionally used for controlling the fresh gas quantity to be supplied to the internal combustion engine of a motor vehicle. Throttle valve assemblies comprise a housing with a continuous throttle orifice and a throttle member arranged in the throttle orifice. The throttle member is often designed as a throttle valve and assumes a defined position in the throttle orifice for the passage of a defined fresh gas quantity. For this purpose, the throttle valve can be activated mechanically or electronically.

The throttle valve of a throttle valve assembly can be moved in a partial range, for example the idling range, by an actuating drive and can be moved in the remaining range with the aid of a wire cable coupled to the accelerator pedal of the motor vehicle. Alternatively, however, the throttle valve may also be capable of being moved over its entire range of adjustment by an actuating drive.

In these last-mentioned systems, there is no mechanical connection between the desired-value instruction, in particular the accelerator pedal, and the throttle valve. In these E-gas or drive-by-wire systems, as they are known, the power requirement, triggered by the depression of the accelerator pedal, is converted into an electrical signal. The electrical signal is supplied to a control unit which, in turn, generates an activation signal for the actuating drive from the electrical signal.

In order to avoid errors in E-gas systems during the transmission of the activation signal from the control unit to the drive of the throttle valve shaft, there are throttle valve assemblies in which the control unit for the actuating drive is integrated into the housing of the throttle valve assembly. The control unit may in this case be integrated into electronics arranged in the housing. The electronics are in this case provided for further functions of the throttle valve assembly, for example for activating a position check of the throttle valve shaft and for the detection and storage of data of the throttle valve assembly. Integration of the electronics into the housing of the throttle valve assembly often entails a particularly high outlay in terms of production and assembly, since the housing must additionally have a receptacle for the electronics. Moreover, for mounting the throttle valve assembly, an additional mounting step is necessary, in which the electronics are integrated into the housing of the throttle valve assembly.

To determine the load of an internal combustion engine, in particular of a gasoline engine of a passenger car, normally the air mass flowing through the throttle orifice of the throttle valve assembly is measured by means of an air mass sensor. However, the air mass sensor, HFM, necessary for this purpose is technically complicated and, particularly in the case of a mass production of throttle valve assemblies, is an appreciable cost factor. Moreover, if the air mass sensor is contaminated, the measurement result is falsified. It is therefore necessary for the air mass sensor to be exchanged at regular time intervals or as required.

### SUMMARY OF THE INVENTION

The object on which the invention is based is, therefore, to specify a throttle valve assembly of the abovementioned type, which by particularly simple means reliably ensures, even over particularly long periods of time, an especially reliable determination of the air mass flowing through the throttle orifice.

This object is achieved, according to the invention, in that a first sensor for the temperature T of the gaseous medium is arranged upstream of the throttle valve and a second sensor for the pressure T of the gaseous medium is arranged downstream of the throttle valve.

The invention in this case proceeds from the consideration that an air mass sensor for a throttle valve assembly, said air mass sensor ensuring especially reliable measurement results even over particularly long periods of time, should be protected against impurities. However, particularly in an intake air duct of a passenger car, this can be ensured only at particularly high outlay by the installation of a complicated filter system. Alternatively to direct air mass measurement, however, there is the possibility of indirectly determining the air mass flowing through the throttle orifice of the throttle valve assembly. A temperature sensor and a pressure sensor are appropriate for this purpose. The air mass flowing through the throttle orifice can be determined reliably from the temperature of the air and the pressure of the air. Moreover, to measure the pressure and temperature of the air stream flowing through the throttle orifice, standard sensors can be used which, even in the case of mass productions, do not make any appreciable contribution to the costs. In order to ensure reliably a measurement of the pressure of the air stream flowing through the throttle orifice, for this purpose, the pressure sensor is arranged downstream of the throttle valve in the flow direction and the temperature sensor is arranged upstream of the throttle valve in the flow direction.

Advantageously, the first sensor provided for the temperature T of the gaseous medium is arranged on the housing of the throttle valve assembly and projects at least partially into the throttle orifice. Integration of the temperature sensor into the housing of the throttle valve assembly allows a premounting of the temperature sensor in the housing of the throttle valve assembly, so that the temperature sensor can then be arranged, together with the housing of the throttle valve assembly, between the inlet line and the outlet line. As a result, the outlay necessary for the throttle valve assembly and for mounting the temperature sensor is particularly low.

Advantageously, the second sensor provided for the pressure P of the gaseous medium is arranged in the housing and is connected to the throttle orifice via a duct arranged in the housing. Arranging the pressure sensor in the housing protects the pressure sensor particularly reliably against contamination.

Advantageously, the housing can be closed by a housing cover, the housing cover having arranged in it electronics for the first sensor provided for the temperature T of the gaseous medium and for the second sensor provided for the pressure P of the gaseous medium. If the housing has electronics for both sensors, the signals from the sensors can be transmitted to the electronics particularly reliably on account of the short distance between the sensors and the electronics, with the result that errors due to signal transmissions or faults in the transmission lines are avoided especially reliably.

Advantageously, the electronics also comprise the control of the actuating drive. Furthermore, advantageously, the throttle valve shaft is connected to a position detection device which can be read out via the electronics. Thus, in the electronics, all the detected data of the throttle valve assembly can be read out and can be processed for further purposes in the motor vehicle.

Advantageously, the electronics are arranged on a circuit board. If the electronics are arranged on a circuit board before installation in the housing, in particular with the aid of integrated circuits, the electronics can be integrated into the housing in a single mounting step. The electronics can then be connected by means of suitable connections both to units outside the housing and to sensors arranged in or on the throttle valve assembly.

Advantageously, the electronics are connected to the position detection device and to the actuating drive via a plug connection. Owing to the spatial proximity of the position detection device and actuating drive, a connection between the electronics and the position detection device, on the one hand, and the electronics and the actuating drive, on the other hand, can be made by means of a single component.

The advantages achieved by means of the invention are, in particular, that, due to the indirect measurement of the air mass flowing through the throttle orifice by means of sensors which are especially unsusceptible to contamination, a measurement of the air mass flowing through the throttle orifice is ensured especially reliably, even over particularly long periods of time, when the throttle valve assembly is in operation.

### BRIEF DESCRIPTION OF THE SEVERAL VIEWS OF THE DRAWINGS

An exemplary embodiment of the invention is explained in more detail with reference to a drawing in which:

FIG. 1 shows diagrammatically a throttle valve assembly in an exploded illustration,

FIG. 2 shows diagrammatically the arrangement of the sensors in the housing of a throttle valve assembly according to FIG. 1, and

FIG. 3 shows diagrammatically the arrangement of the sensors downstream and upstream of the throttle valve assembly.

### DETAILED DESCRIPTION OF THE INVENTION

Parts corresponding to one another are given the same reference symbols in all the figures.

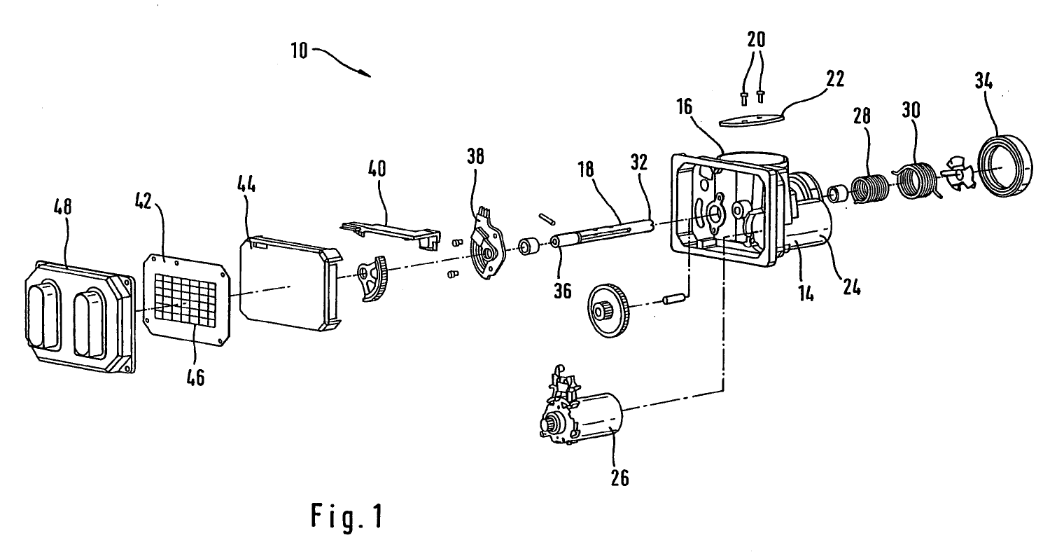

The throttle valve assembly 10 according to FIG. 1 serves for supplying an air or fuel/air mixture to a consumer, not illustrated, for example an injection device of a motor vehicle, likewise not illustrated, the fresh gas quantity to be supplied to the consumer being capable of being controlled by means of the throttle valve assembly 10. For this purpose, the throttle valve assembly 10 has a housing 12 which is manufactured predominantly from aluminum 14. Alternatively, however, the housing may also be manufactured from plastic. The housing 12 comprises a continuous throttle orifice 16, via which an air or fuel/air mixture can be supplied to the consumer, not illustrated. To set the volume of fresh gas to be supplied, a throttle valve 22 is arranged on a throttle valve shaft 18 with the aid of fastening means 20. The throttle valve shaft 18, the fastening means 20 and the throttle valve 22 are shown in an exploded illustration in FIG. 1.

A rotation of the throttle valve shaft 18 gives rise simultaneously to a pivoting of the throttle valve 22 arranged on the throttle valve shaft 18. A pivoting of the throttle valve 22 causes an increase or decrease in size of the opening of the throttle orifice 16. As a result, the quantity of flow medium flowing through the throttle orifice 16 can be set. Thus, by means of a movement of the throttle valve 22, a regulation of the throughput of the air or fuel/air mixture through the throttle orifice 16 of the throttle valve assembly 10 takes place.

The throttle valve shaft 18 may be connected to a cable pulley, not illustrated in any more detail, which, in turn, is connected to a setting device for a power requirement via a Bowden pull control. The setting device may in this case be designed as an accelerator pedal of a motor vehicle, so that, by this setting device being actuated by the driver of the motor vehicle, the throttle valve 22 can be brought from a position of minimum opening, in particular a closing position, into a position of maximum opening, in particular an open position, in order thereby to control the power output of the motor vehicle.

In contrast to this, the throttle valve shaft 18, shown in FIG. 1, of the throttle valve assembly 10 either can be set in a partial range by an actuating drive and otherwise via the accelerator pedal or else the throttle valve 22 can be set over the entire range of adjustment by an actuating drive. In these E-gas or drive-by-wire systems, as they are known, the mechanical power control, for example the depression of an accelerator pedal, is converted into an electrical signal. This signal, in turn, is supplied to a control unit which generates an activation signal for the actuating drive. In normal operation, there is no mechanical coupling between the accelerator pedal and the throttle valve 22 in these systems.

To adjust the throttle valve shaft 18 and consequently the throttle valve 22, the throttle valve assembly 10 has a drive housing 24. The drive housing 24 is produced in one piece with the housing 12 of the throttle valve assembly 10. Alternatively, the housing 12 of the throttle valve assembly 10 and the drive housing 24 may also be produced in two pieces. An electrical actuating drive 26 designed as an electric motor is arranged in the drive housing 24. The electrical actuating drive 26 designed as an electric motor is connected to the throttle valve shaft 18 via a gear unit 28. The throttle valve shaft 18 can thus be pivoted by the actuating drive 26 designed as an electric motor.

The throttle valve 22 is acted upon via the throttle valve shaft 18 by a return spring 28 so as to be capable of being pivoted back into a basic position. An emergency running spring 30 ensures, furthermore, that, in the event of a failure of the electrical actuating drive 26 designed as an electric motor, the throttle valve is not closed completely, so that, despite the failure of the actuating drive 26 designed as an electric motor, an albeit only slight drive power of the motor vehicle is reliably ensured. The return spring 28 and the emergency running spring 30 are arranged at a first end 32 of the throttle valve shaft 18. The housing 12 can be closed at this end by a first cover 24. At the second end 36 of the throttle valve shaft 18 is arranged a position detection device 38, designed as a potentiometer, for detecting the in each case current position of the throttle valve shaft 18 and consequently, indirectly, of the throttle valve 22.

The position detection device 38 designed as a potentiometer and the actuating drive 26 designed as an electric motor are connected to a circuit board 42 with the aid of a plug connection 40. The circuit board 42 is in this case separated by means of a cover plate 44 from the housing region in which the potentiometer 38 and the actuating drive 26 designed as an electric motor are arranged. The cover plate 44 reliably protects the circuit board 42 against the impurities which are unavoidable due to the operation of the mechanical elements in the throttle valve assembly 10. The electronics 46 for the actuating drive 26 designed as an electric motor and for the position detection device 38 designed as a potentiometer are arranged on the circuit board 42. The circuit board 42 is to be arranged in a cover 48 during the mounting of the throttle valve assembly 10, the housing 12 of the throttle valve assembly 10 being capable of being closed by means of the cover 48 from the side facing away from the spring system.

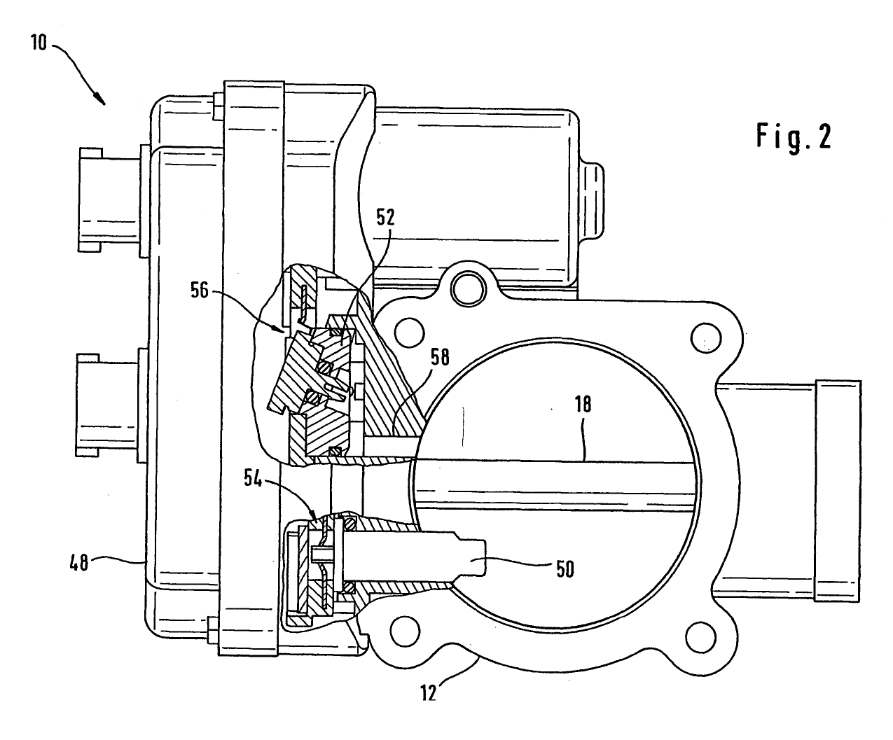

In order, when the throttle valve assembly 10 is in operation, to determine the air mass flowing through the throttle orifice 16, according to FIG. 2 a temperature sensor 50 and a pressure sensor 52 are arranged in the throttle valve assembly 10. The temperature sensor is in this case arranged upstream of the throttle valve 22 and the pressure sensor 52 is arranged downstream of the throttle valve 22 on the housing 12 of the throttle valve assembly 10. The temperature sensor 50 is connected via an electrical plug connection 54 to the electronics 46 which are arranged on the circuit board 42 and cannot be seen in FIG. 2 since it is arranged in the cover 46 of the housing 12. The temperature sensor 50 projects into the throttle orifice 16. It is a conventional component for the measurement of temperature.

The pressure sensor 52 is arranged downstream of the throttle valve 22 in the housing 12 of the throttle valve assembly 10. The pressure sensor 52 is likewise connected by means of an electrical plug connection 56 to the electronics 48 arranged on the circuit board 42, this likewise not being illustrated in any more detail in FIG. 2. The pressure sensor 52 is connected to the throttle orifice via a duct 58 arranged in the housing 12.

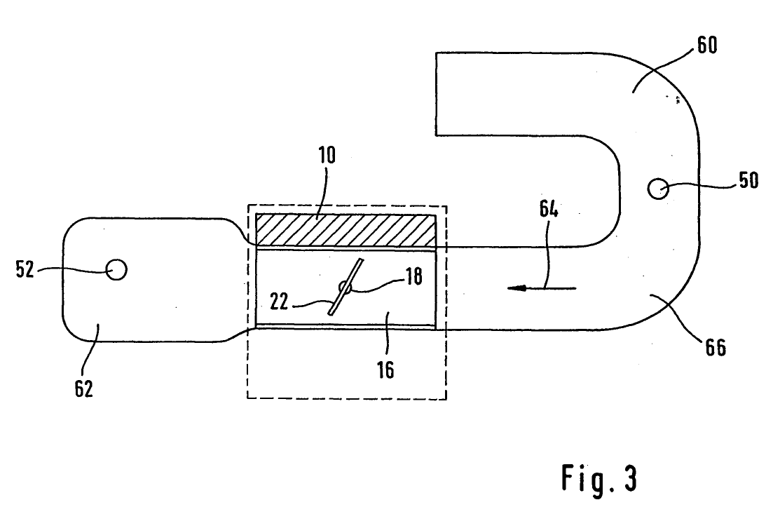

Alternatively to FIG. 1, the temperature sensor 50 and the pressure sensor 52 may also be arranged, according to FIG. 3, in lines to which the throttle valve assembly 10 is connected. FIG. 3 shows an inlet line 60, to which the throttle valve assembly 10 is connected on the inlet side, and an outlet line 62, to which the throttle valve assembly 10 is connected on the outlet side. The throttle valve assembly 10 is illustrated diagrammatically in this case. Thus, according to FIG. 3, the throttle valve assembly is connected on the inlet side to an air supply line as the inlet line 60 and on the outlet side to an outlet line 62 which is designed as a pressure line. According to FIG. 3, the temperature sensor 50 is arranged in the inlet line 60 and the pressure sensor 52 in the outlet line 62.

When the throttle valve assembly 10 is in operation, gaseous medium 66, which takes the form of air in this exemplary embodiment, is supplied to the throttle orifice 16 of the throttle valve assembly 10. The gaseous medium 66 has, upstream of the throttle valve 22 of the throttle valve assembly 10, a specific temperature T which can be detected by means of the temperature sensor 50. Downstream of the throttle valve 22 of the throttle valve assembly 10, the air has a specific pressure which can be detected by means of the pressure sensor 52. The pressure and/or temperature values detected at defined time intervals can be supplied in a way not illustrated in any more detail to the electronics 46 of the throttle valve assembly 10 which are arranged on the circuit board 42. The electronics 46 of the circuit board 42 have suitable evaluation electronics, by means of which the air flowing through the throttle orifice (16) can be determined from the detected pressure and/or temperature data. In addition, the electronics have further modules by means of which the in each case currently determined air mass can be linked to other information of the motor vehicle and evaluated.

The indirect measurement of the temperature and pressure of the air mass flowing through the throttle orifice 16 of the throttle valve assembly 10 ensures especially reliably that the air mass flowing through the throttle orifice 16 can be determined reliably even at particularly long time intervals.

We claim:

1. A throttle valve assembly (10) with a housing (12) which has a throttle orifice (16) through which a gaseous medium (66) is capable of flowing in a main flow direction (64), a throttle valve (22) fastened pivotably on a throttle valve shaft (18) being arranged in the throttle orifice (16), the throttle valve shaft (18) being pivotable by an actuating drive (26), and the throttle orifice (16) being connected on the inlet side to an inlet line (60) and on the outlet side to an outlet line (62), wherein a first temperature sensor (50) for the temperature T of the gaseous medium (66) is arranged upstream of the throttle valve (22) and a second pressure sensor (52) for the pressure P of the gaseous medium (66) is arranged downstream of the throttle valve (22).

2. The throttle valve assembly (10) according to claim 1, wherein in that the first temperature sensor (50) provided for the temperature T of the gaseous medium (66) is arranged on the housing (12) and projects at least partially into the throttle orifice (16).

3. The throttle valve assembly (10) according to claim 1, wherein the second pressure sensor (54) provided for the pressure P of the gaseous medium (66) is arranged in the housing (12) and is connected to the throttle orifice (16) via a duct (58) arranged in the housing (12).

4. The throttle valve assembly (10) according to claim 1, wherein the housing (12) can be closed by a housing cover (48), electronics (46) for the first temperature sensor (50) and for the second pressure sensor (52) being arranged in the housing cover (48).

5. The throttle valve assembly (10) according to claim 4, wherein the electronics (46) also comprise the control of the actuating drive (26).

6. The throttle valve assembly (10) according to claim 1, wherein the throttle valve shaft (18) is connected to a position detection device (38) which can be read out via the electronics (46).

7. The throttle valve assembly (10) according to claim 4, wherein the electronics (46) are arranged on a circuit board (42).

8. The throttle valve assembly (10) according to claim 4, wherein the electronics (10) are connected to the position detection device (38) and to the actuating drive (26) via a plug connection.
